(19) United States
(12) Patent Application Publication
(10) Pub. No.: US 2021/0227860 A1
(43) Pub. Date: Jul. 29, 2021

(54) NIXTAMALIZATION PROCESS AND DERIVED COMPOSITIONS BIOENRICHED WITH SELENIUM

(71) Applicant: Instituto Tecnológico y de Estudios Superiores de Monterrey, Monterrey (MX)

(72) Inventors: Daniela Guardado-Félix, Monterrey (MX); Sergio Romàn Othón Serna-Saldívar, Monterrey (MX)

(21) Appl. No.: 16/840,076

(22) Filed: Apr. 3, 2020

Related U.S. Application Data
(60) Provisional application No. 62/964,727, filed on Jan. 23, 2020.

(51) Int. Cl. A23L 7/10; B02B 1/04; A23L 33/16; A21D 13/047

(52) U.S. Cl. CPC A23L 7/198; B02B 1/04; A23V 2002/00; A21D 13/047; A23L 33/16

(57) ABSTRACT

This disclosure provides methods for producing nixtamal, in particular from corn and other grains, with an increased level of selenium, and food products produced therefrom.

### CROSS-REFERENCE TO RELATED APPLICATIONS

This application claims the benefit of U.S. Provisional Application No. 62/964,727, filed Jan. 23, 2020, herein incorporated by reference in its entirety.

### FIELD OF THE INVENTION

The present disclosure relates to the field of food science. More specifically, the present disclosure related to modified nixtamalization processes to produce corn and other grain with increased levels of selenium.

### BACKGROUND OF THE INVENTION

Cereals-based foods supply most of the calories and proteins consumed by mankind. These starchy foods provide more than 60% of the total caloric and 50% of the total protein intake in the world. Most cereal-based foods are produced from white-polished rice, wheat and corn especially important in Asia, Europe/USA/Canada and Latin America, respectively. Tortillas are the main staple food for many Latin American populations and their derived products corn chips and tortilla chips the second most important salty snack food in the planet with sales exceeding 7 billion dollars. The key of the tortilla making process is the cooking of mature corn kernels in a lime (calcium hydroxide) solution, a process termed nixtamalization. This alkaline treatment promotes important changes in the kernel such as starch gelatinization, protein denaturation, disruption of fibrous containing cell walls and the higher availability of vitamins like niacin or vitamin B3. Nutritionally, tortillas contain higher amounts of bioavailable calcium, which is considered as one of the most relevant minerals in human nutrition.

Selenium (Se) is a trace element essential for humans. The biological roles of this mineral include the protection of tissues against oxidative stress, the maintenance of the body's defense systems against infection, and the modulation of growth and development. The importance of Se intake in human well-being has been acknowledged by health and agriculture global organizations. Se recommended nutrient intakes for healthy adults were established by the Word Health Organization at 50-70 μg Se/day for a 70 kg adult. However, these values may change according to the nutritional needs of each country. The Panel of European Food Safety Authority specifies L-Selenomethionine (SeM) daily intake of 100-400 μg/day as Se. Typically 200 μg/day as Se are used in food supplements.

The daily intake of supra-nutritionals levels of Se (200-300 μg) stimulates antioxidant protection mechanisms mainly due to enhanced glutathione peroxidase (GPx) activity. It has been shown that the daily consumption of 1.2 μg Se/kg (plasma total Se level, 106 ng/ml) safely reduces the risk of practically all types of cancer. Moreover, the biological and cancer preventive activities are determined by form and dosage of Se. Furthermore, it has been demonstrated that organic forms such as SeM are preferred over inorganic types.

The role of SeM in cancer prevention has been demonstrated in numerous investigations with in vitro cellular models, a variety of animal studies and in several clinical trials. However, these evidences are not always consistent and sometimes ambiguous or controversial. Animal trials have shown the protective effects of Se against aberrant crypt formation and colon tumor development.

An impressive body of evidence supports the concept that dietary habits are key modulators of colorectal cancer. Studies on nutritional selenium status in the general population of several countries showed that bread and breakfast cereals are considered the major dietary sources. Se-enriched breads may contain the 50 μg recommended intake or provide supra nutritional levels of 200 μg/100 g bread in the form of SeM.

Despite the many potential health benefits of Se, the mechanisms of action by which this mineral promotes better health are only beginning to be elucidated. Se-supplementation can modify the genome stability by nutrient-nutrient and nutrient-gene interaction protecting against DNA damage events such as an increase in DNA strand breaks, oxidation and telomere shortening. Another proposed mechanism is that the 20 known selenoproteins in mammals exert health benefits. These proteins are divided into three groups: proteins into which Se is incorporated nonspecifically, specific Se-binding proteins, and proteins that contain this mineral in the form of selenocysteine. In the last mentioned group, the relevant enzymes glutathione peroxidases (GPX) and superoxide dismutase (SOD) are included. These are the most relevant enzymes of the cell antioxidant defense system. Se incorporated as methylselenic acid might participate in cell cycle arrest, caspases/apoptosis, antiangiogenesis and other mechanisms for cancer prevention. Additional information suggested that Se may have an important role in immune function, mammalian development and male reproduction, and in slowing the aging process.

The role of Se in cancer prevention has been clearly demonstrated; however, controversy remains on the possible advantages and risks of selenium in cancer prevention. The SELECT human trial concluded that Se supplementation did not provide an eminent benefit. The inventors have previously investigated the protective effects of yeast-leavened breads, sprouted chickpeas with supra-nutritional levels of dietary SeM using immune-suppressed mice (SCID CB.17) bearing human colorectal adenocarcinoma HT-29 (Gutierrez Diaz, Maestría en Ciencias en Biotecnología. Instituto Tecnológico y de Estudios Superiores de Monterrey, Monterrey, N. L., México 2011; Guardado Felix et al., J. Functional Foods 56:73-84, 2019). In both studies the supra-nutritional levels of SeM synthesized by yeast during dough fermentation or provided by the sprouted and selenium enriched chickpeas enhanced GPx activity and the protective effects against colon cancer especially via genes involved with apoptosis. The molecular mechanisms by which Se is considered as chemopreventive are not fully elucidated. However, it is known that the form and dosage of organic and inorganic Se forms are determinants of the biological and cancer preventive activities. The antioxidant protection of selenoproteins, the specific inhibition of tumor cell growth by Se metabolites, the modulation of cell cycle and apoptosis, and the effect on DNA repair have been proposed as the main mechanism of action by which Se is chemoprotective against various forms of cancer.

What is needed, therefore, are methods for producing nixtamal, in particular from corn and other grains, with an increased level of Se, and food products produced therefrom.

### SUMMARY

The present disclosure provides methods for producing nixtamal, in particular from corn and other grains, with an increased level of Se, and food products produced therefrom.

The present disclosure provides a method of producing nixtamal comprising an increased level of selenium from a cereal, pulse/legume, oilseed or pseudocereal, comprising the steps of: a) tempering, conditioning or soaking the cereal, pulse/legume, oilseed or pseudocereal in a solution comprising a selenium salt; b) germination of the tempered, conditioned or soaked cereal, pulse/legume, oilseed or pseudocereal to produce a sprouted cereal, pulse/legume, oilseed or pseudocereal; c) cooking the sprouted cereal, pulse/legume, oilseed or pseudocereal in a solution comprising lime, calcium hydroxide, wood ashes, potassium hydroxide or sodium hydroxide; d) steeping the cooked and sprouted cereal, pulse/legume, oilseed or pseudocereal in the solution; and e) draining the solution from the cooked and sprouted cereal, pulse/legume, oilseed or pseudocereal to produce nixtamal comprising an increased level of selenium. In certain embodiments the method further comprises the step of washing the nixtamal. In some embodiments the terms grain and grain legumes are used interchangeably with the terms cereal, pulse/legume, oilseed or pseudocereal.

In certain embodiments the cereal is corn, rice, wheat, barley, sorghum, millet, oats, rye, triticale, fonio, teff, wild rice or pearl, foxtail or Italian or Japanese or other related millet. In particular embodiments the cereal is corn. In some embodiments the pulse/legume is soybean, green peas, yellow or other colored peas, kidney bean, navy bean, pinto bean, black turtle bean, haricot bean, lima bean, butter bean, adzuki bean, mung bean, black gram, urad, scarlet runner bean, ricebean, moth bean, tepary bean, horse bean, broad bean, field bean, garden pea, protein pea, chickpea or garbanzo, bengal gram, dry cowpea, black-eyed pea, blackeye bean, pigeon pea, arhar/toor, cajan pea, congo bean, gandules, lentil, bambara groundnut, earth pea, vetch, common vetch, lupins, hyacinth bean, jack bean, winged bean, velvet bean, cowitch, or yam bean. In other embodiments the oilseed is soybean, peanut, castor bean, sunflower seed, rapeseed or canola, safflower seed, sesame seed, mustard seed, poppy seed, melonseed, hempseed, flax or linseed. In still other embodiments the pseudocereal is amaranthus, buckwheat, chia, quinoa or huauzontle.

In additional embodiments the cereal, pulse/legume, oilseed or pseudocereal is tempered or conditioned prior to germination. In other embodiments the cereal, pulse/legume, oilseed or pseudocereal is soaked prior to germination. In certain embodiments the cereal, pulse/legume, oilseed or pseudocereal is soaked for about 8 to about 24 hours at about 20-25° C. prior to germination. In further embodiments the soaked cereal, pulse/legume, oilseed or pseudocereal has a moisture of at least 34%. In yet further embodiments the soaked cereal, pulse/legume, oilseed or pseudocereal has a moisture of about 36% to about 38%. In some embodiments the tempered, conditioned or soaked cereal, pulse/legume, oilseed or pseudocereal is germinated for about 24 to about 72 hours at about 20-25° C. at about 85% relative humidity. In other embodiments the sprouted cereal, pulse/legume, oilseed or pseudocereal is cooked at about 85-100° C. for about 1 to about 10 minutes. In yet other embodiments the cooked and sprouted cereal, pulse/legume, oilseed or pseudocereal is steeped for about 8 to about 16 hours.

In certain embodiments the selenium salt is sodium selenite, potassium selenite or selenium dioxide. In some embodiments the solution comprises about 10 mg/liter to about 25 mg/liter of the selenium salt. In particular embodiments the nixtamal comprises a nutritional level of selenium, while in other embodiments the nixtamal comprises a supra-nutritional level of selenium.

In certain embodiments the nixtamal is ground to produce masa or dough particles. In some embodiments the masa or dough particles have a fine granulometry. In particular embodiments the masa or dough particles having a fine granulometry are used to produce tortillas. In more particular embodiments the masa or dough particles having a fine granulometry are produced from corn and are used to produce corn tortillas. In other embodiments the masa or dough particles have a coarse granulometry. In some embodiments the masa or dough particles having a coarse granulometry are used to produce snack chips or tostadas. In particular embodiments the masa or dough particles having a coarse granulometry are produced from corn and are used to produce corn snack chips or corn tostadas. In further embodiments the masa or dough particles are dried or dehydrated.

The present disclosure also provides food products produced from cereal, pulse/legume, oilseed or pseudocereal nixtamal comprising an increased level of selenium. In certain embodiments the food product comprises a nutritional level of selenium. In other embodiments the food product comprises a supra-nutritional level of selenium. In some embodiments the food product is produced from corn nixtamal comprising an increased level of selenium. In particular embodiments the food product is corn tortillas, corn snack chips or corn tostadas. In further embodiments the cereal, pulse/legume, oilseed or pseudocereal nixtamal comprising an increased level of selenium is produced using a method comprising the steps of: a) tempering, conditioning or soaking the cereal, pulse/legume, oilseed or pseudocereal in a solution comprising a selenium salt; b) germination of the tempered, conditioned or soaked cereal, pulse/legume, oilseed or pseudocereal to produce a sprouted cereal, pulse/legume, oilseed or pseudocereal; c) cooking the sprouted cereal, pulse/legume, oilseed or pseudocereal in a solution comprising lime, calcium hydroxide, wood ashes, potassium hydroxide or sodium hydroxide; d) steeping the cooked and sprouted cereal, pulse/legume, oilseed or pseudocereal in the solution; and e) draining the solution from the cooked and sprouted cereal, pulse/legume, oilseed or pseudocereal to produce nixtamal comprising an increased level of selenium.

The present disclosure additionally provides corn tortillas, corn snack chips or corn tostadas comprising an increased level of selenium. In some embodiments the corn tortillas, corn snack chips or corn tostadas comprise a nutritional level of selenium. In other embodiments the corn tortillas, corn snack chips or corn tostadas comprise a supra nutritional level of selenium.

### BRIEF DESCRIPTION OF THE DRAWINGS

Those of skill in the art will understand that the drawings, described below, are for illustrative purposes only. The drawings are not intended to limit the scope of the present teachings in any way.

FIG. 1A and FIG. 1B. Flowcharts of industrial processes to produce sprouted corn with modulated levels of organic selenium suited for production of nixtamalized products. FIG. 1A. Tempering Procedure. FIG. 1B. Soaking Procedure.

FIG. 2. Flowchart of industrial processes for production of selenium-enriched corn tortillas, corn chips and tortilla chips.

FIG. 3. Flowchart of industrial processes for production of selenium-enriched dry masa flours for tortillas, corn chips and tortilla chips.

FIG. 4. Effect of lime-cooking time on nixtamal moistures (Panel A) and dry matter losses (Panel B) of germinated corns from 1 to 3 days.

### DETAILED DESCRIPTION

The present disclosure provides processes for producing cereal grains, including, but not limited to, corn, wheat and rice, with increased levels of selenium (Se), and food products produced from such cereal grains. In certain aspects the present disclosure provides processes for the production of tortillas and related products (tortilla chips, corn chips, porridges) following a modified nixtamalization procedure in which mature corn kernels are purposely germinated in the presence of selenium salts (i.e., sodium selenite) during a given period of time and temperature so the trace mineral is first absorbed by the sprouting grain and then metabolized into organic forms. Then, the wet and sprouted kernels with the desired levels of selenium are lime-cooked in order to obtain nixtamal with 45 to 52% moisture for fresh masa operations or 33 to 40% moisture for dry masa flour operations. The lime-cooking procedure is modified because kernels are processed wet and enzymes produced during germination make kernels more prone to cooking. In general terms the cooking times are reduced to about 1/10 or less of the required by normal kernels with the corresponding saving in energy. Then, the cooking liquor or nejayote is discarded and the nixtamal with the targeted moisture content is washed with water and wet ground into a masa suitable for table tortillas, tortilla chips, tamales or other related food applications. Alternatively, the wet whole nixtamal or ground masa can be dehydrated to produce a shelf-stable dry masa flour with less than 12% moisture. The level of selenium is controlled by the addition of sodium selenite or alternatively any other selenium source during the germination process and the incurred losses of this mineral during the lime-cooking, nixtamal draining and nixtamal washing operations. The wet dough or masa or dehydrated masa flour can be used to further produce table tortillas, corn chips, tortilla chips, lime-cooked porridges (atole) and other related foods like steamed-cooked tamales following conventional procedures. With these new processes, the levels of selenium in nixtamal, masa (dry and wet versions), tortillas and related nixtamalized products can be controlled to provide preventive and therapeutic dosages that are known to benefit human health.

### Example 1

The present example provides methods to manufacture nixtamal, masa, tortillas and related products from sprouted corn kernels containing different amounts of supplemented selenium. Sprouted kernels are lime-cooked into nixtamal using significantly lower cooking schedules in order to obtain products with preconceived amounts of this mineral and degree of starch gelatinization so the ground masa with adequate machinability is suited for further processing into table or soft tortillas, corn chips, tortilla chips, tostadas, porridges and other nixtamalized products. Alternatively, the whole nixtamal or ground masa can be dehydrated, classified and further dry-milled into a dry masa flour with the desired particle size distribution. The final levels of selenium can be controlled by the amount supplemented during the sprouting process (soaking and germination) and the losses incurred during lime-cooking and nixtamal washing. Using the presently disclosed methods 100 grams of tortillas can contain standardized total selenium levels ranging from 25 to 100 micrograms. Most of this selenium is associated to organic forms like selenium methionine that is known to be more bioavailable and less toxic to humans.

The process used in this example is comprised of sprouting of corn kernels with controlled levels of selenium, and lime-cooking of sprouted kernels with high levels of selenium.

Sprouting of Corn Kernels with Controlled Levels of Selenium

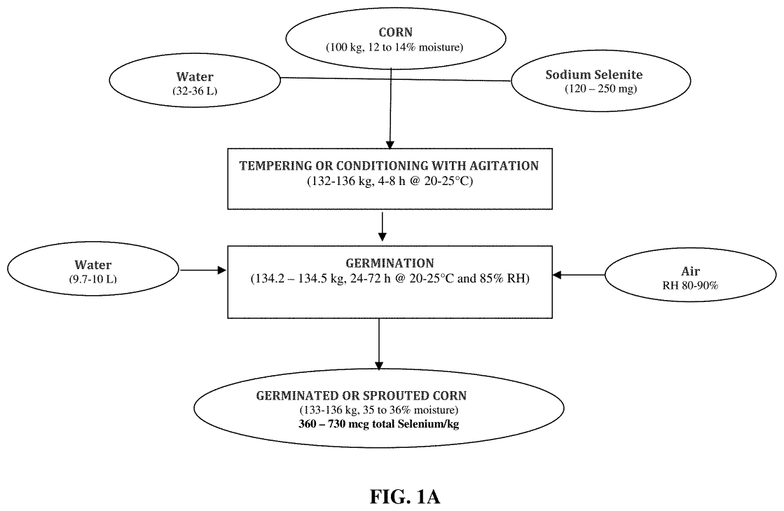

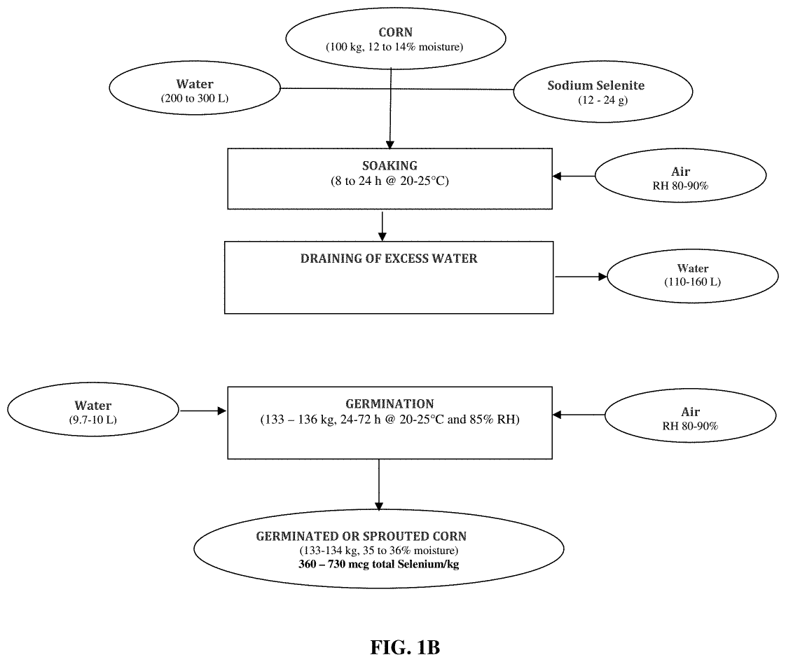

Mature corn kernels containing from 12 to 15% moisture are cleaned with aspiration, gravity tables and related equipment to separate damaged kernels and dockage or extraneous material. Then, the cleaned kernels are alternatively disinfected with a sodium hypochlorite solution followed by one or various water rinses. Then, kernels are single or double tempered with water containing controlled amounts of sodium selenite or other selenium containing sources in order to increase the moisture content of the soaked kernels to 34 to 40% (FIG. 1A). The grain is generally agitated until all the water is absorbed by the kernel. An alternative method (FIG. 1B) is to simply soak kernels in excess water containing sodium selenite for at least 12 hours, and in some embodiments for 24 hours, at temperatures of 15 to 30° C. with air bubbling that creates aerobic conditions. The soaking enhances water permeation into the grain so it activates the phytohormone gibberellin responsible of the subsequent germination process. Then the soaked kernels are germinated or malted under controlled conditions of temperature, air relative humidity and time. The grains can be germinated for 1 up to 3 days depending on temperature, desired degree of grain modification and generation of important enzymes like amylases, xylanases and proteases. The ideal germination time is when kernels metabolize most of the inorganic selenium into organic forms and they still have low enzymatic activity.

Corn kernels (100 g) were hydrated with excess water containing different amounts of sodium selenite Na₂SeO₃ (0, 12 and 24 mg/L) (1:3 w/v) at 25° C. for 8 hours (FIG. 1B). The soaked grains were transferred and dispersed uniformly on plastic trays (40×30 cm) to facilitate germination. The germination process was maintained in dark conditions at 23±1° C. and 80% relative humidity for 3 days. The grains were sprayed with 10 mL of distilled water every 12 hours. The α-amylase activity of grains was determined using the spectrophotometric method at 400 nm according to AACC (American Association of Cereal Chemists. Approved methods of the AACC, 10th edn. Association, St. Paul, Minn., pp 69-124, 2000, Method 22-02.01) using the commercial kit of Megazyme Ceralpha Assay Kit (Megazyme International, Ireland). The method reported by Guardado-Félix et al. (Food Chemistry 226:69-74, 2017) was followed with some modifications to determine total selenium concentration in germinated corn and tortillas. The analysis consisted first of wet-ashing or hydrolyzing samples of 500 mg with 10 mL of 77% HNO₃ in a microwave digestion oven (Mars 5 CEM, Matthews, N.C., USA) with the following conditions: 15 min increasing from room temperature to 180° C., this temperature was maintained for 10 min and then it was decreased to 50° C. in 20 min. Afterward, the samples volumes were adjusted to 15 mL with double deionized water and transferred to 20 mL vials, which were then stored at −4° C. until further analysis. The selenium content from the acid digestion was quantified using an XSeries 2 inductively coupled plasma mass spectrometer (ICP-MS) (Thermo Scientific, NC, USA) with a Type C glass concentric nebulizer (Meinhard, Mass., USA). The ion intensity at m/z 77 (77Se) was monitored using time-resolved analysis software. Data were expressed as μg/g of samples in dry weight (dw).

The study indicated that basal levels of selenium increased between 2.6 and 3.8 fold in germinated corn in presence of selenium (Table 1). Also, the germination process increased the moisture content of 11% of whole corn to 33.3, 34.9 and 35.7% for germinated at 1, 2 and 3 days, respectively (Table 1). The activity of α-amylase increased with germination time and selenium content. In that way that the highest value was observed in corn germinated for 3 days with 24 mg of sodium selenite. This particular sample contained 58 times more alpha amylase activity compared to the control (Table 1).

TABLE 1
Selenium content, % moisture and α-amylase activity of
germinated corn

| | | α-Amylase | | |
|---|---|---|---|---|
| | | SD | Moisture | Selenium |
| Treatment | | Units/g | (%) | (mcg/g dw) |
| Whole corn | | 0.049^{g} | 11.11 ± 0.03^{d} | 0.154 ± 0.001^{c} |
| Germinated 0* mg | 1 day | 0.079^{f} | 33.34 ± 0.08^{c} | 0.156 ± 0.002^{c} |
| | 2 day | 0.074^{f} | 34.89 ± 0.08^{b} | 0.154 ± 0.001^{c} |
| | 3 day | 0.584^{d} | 35.69 ± 0.06^{a} | 0.155 ± 0.003^{c} |
| Germinated 12* mg | 1 day | 0.059^{g} | 33.07 ± 0.03^{c} | 0.559 ± 0.002^{b} |
| | 2 day | 0.714^{c} | 34.28 ± 0.04^{b} | 0.567 ± 0.001^{b} |
| | 3 day | 2.425^{b} | 35.34 ± 0.03^{a} | 0.565 ± 0.029^{b} |
| Germinated 24* mg | 1 day | 0.106^{e} | 33.04 ± 0.02^{c} | 0.737 ± 0.003^{a} |
| | 2 day | 0.750^{c} | 34.01 ± 0.01^{b} | 0.722 ± 0.008^{a} |
| | 3 day | 2.832^{a} | 35.56 ± 0.03^{a} | 0.154 ± 0.007^{a} |

Means ± standard deviation of three determinations. Mean values in each column sharing the same letter were not significantly different (p < 0.05). 0*, 12* and 24* = mg Na₂SeO₃/L water used during soaking.

Lime-Cooking of Sprouted Kernels with High Levels of Selenium

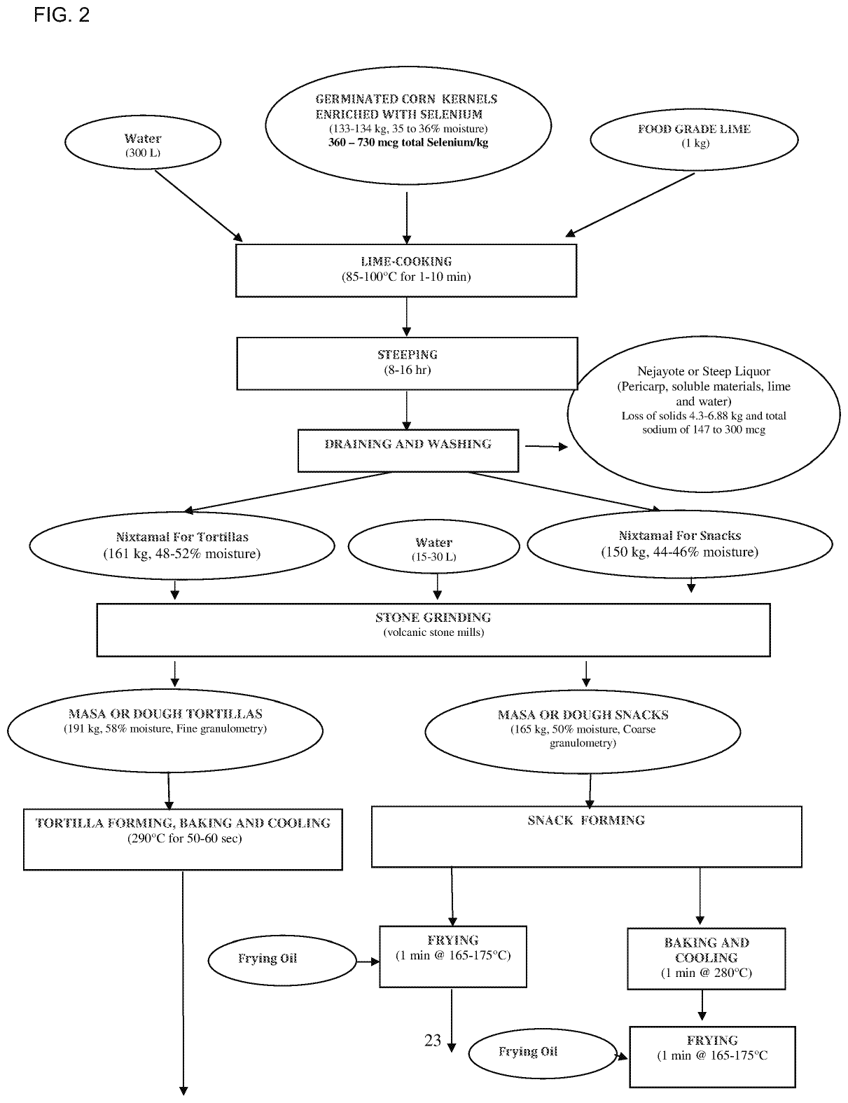

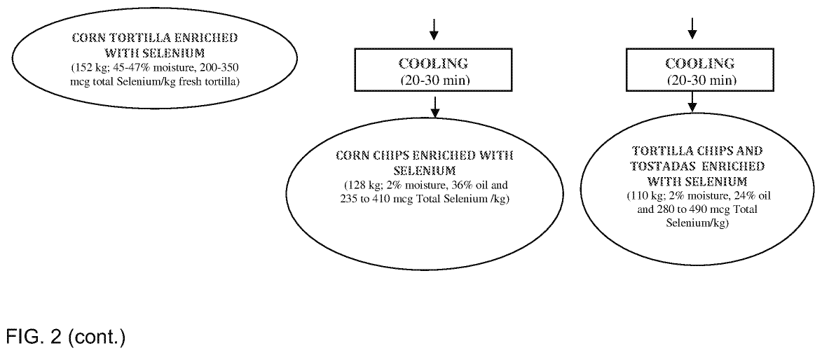

Resulting sprouted kernels with controlled amounts of selenium were subjected to conventional lime-cooking consisting of applying a thermal treatment with preferably food grade lime or calcium hydroxide. The typical formulation consists of cooking at a temperature ranging from 80 to 100° C. 1 part of corn with 3 parts of water and 1% food grade lime based on the original corn weight (FIG. 2). The formulation can be changed in terms of the corn:water ratio and the amount of calcium hydroxide used (0.5 to 2% based on the original corn weight). After the predetermined cooking time, the heat is discontinued and the nixtamal is steeped in the hot lime solution for 8 to 16 hours. Alternatively, the temperature of the cooking liquor can be reduced or quenched to 75-80° C. by adding water. The quenching operation is normally performed for nixtamal suited for snacks because it reduces water absorption. Due to the cooking of sprouted and partially hydrated kernels cooking times can be adjusted so the cooked and stepped nixtamal contains about 48 to 52% moisture for table tortilla application or 44 to 48% moisture for production of nixtamalized snacks (corn chips or fritos and tortilla chips or tostitos) and tostadas. The present studies indicated that the sprouted kernels needed significantly less cooking compared to regular corn kernels. In general terms the corn needed less than 10% of the cooking time required by regular corn with the concomitant savings in energy, labor and use of the production line. Thereafter, the nixtamal is processed using the regular steps required for production of tortillas or chips.

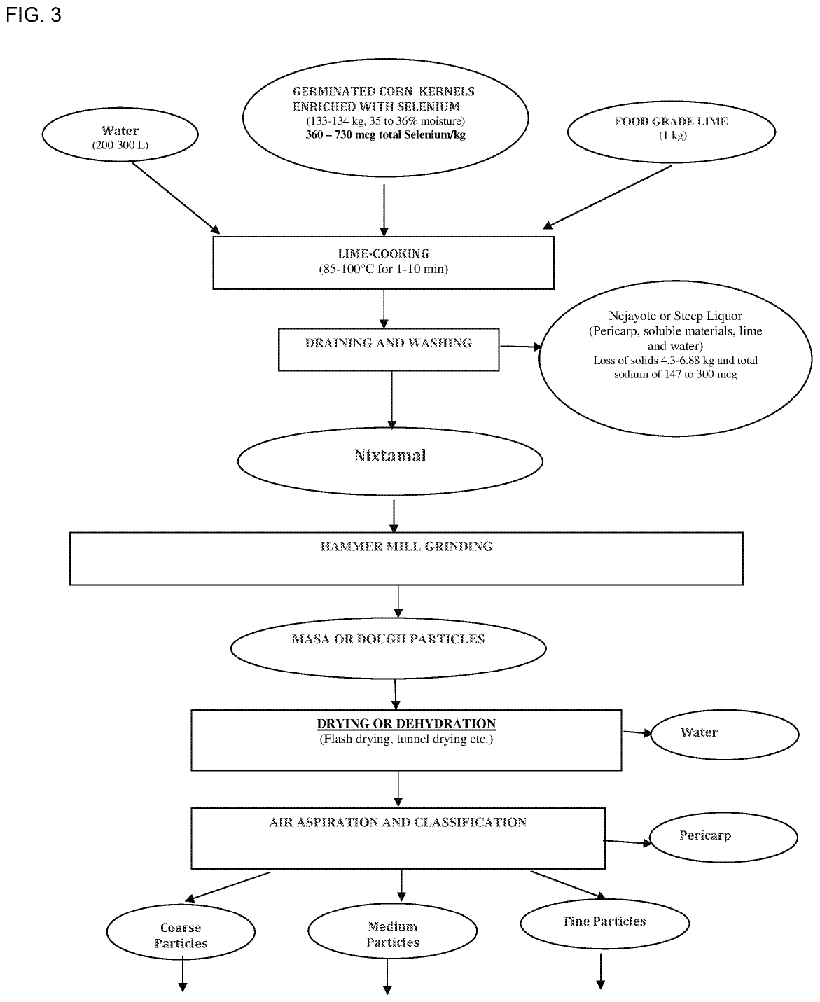

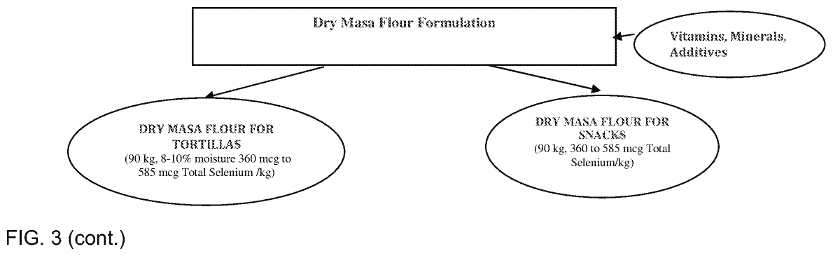

For production of dry masa flour high in selenium (FIG. 3), the sprouted corn kernels are cooked for about 1/10 of the cooking time of regular corn in open, closed or even continuous reactors. The typical formulation consists of cooking 1 part of corn with 2 to 3 parts of water and 1% food grade lime based on the original corn weight. The formulation can be changed in terms of the corn:water ratio and the amount of calcium hydroxide used (0.5 to 2% based on the original corn weight). In this process, the steeping can be skipped so the nixtamal usually contains about 36% moisture after the cooking schedule (FIG. 3). The nixtamal is immediately ground into masa pieces that are dehydrated (flash drying and/or conventional drying in tunnels) to about 8 to 12% moisture and further processed and classified with the same equipment conventionally used by the industry. By this way, an array of dry masa flours with high levels of selenium with different functionalities (particle size distribution, degree of gelatinization or cooking, water absorption index, etc.) for different applications (flour for table tortillas, corn chips, tortilla chips, tamales) can be manufactured.

For both types of processes it was noted that the sprouted kernels lost part of the selenium into the cooking liquor or nejayote and the following step of washing. These studies indicate that sprouted kernels containing 0.55-0.73 μg Se/g dw lost about 41.29-22.94% respectively, of the original content. Therefore, processors should adjust the amounts supplemented during the sprouting process taking into consideration these losses.

### Example 2—Lime-Cooking for Production of Masa and Table Tortillas Enriched with Selenium

The optimum lime-cooking time for whole corn and germinated corn sprouted for 1, 2 and 3 day were determined according to cooking trials in which 100 g samples contained in nylon bags were lime-cooked for 0, 20, and 40 min (Serna-Saldivar et al., Crop Sci. 31:842-844, 1991). Linear regression equations were calculated to predict optimum cooking. The optimum nixtamal moisture or water uptake was the cooking time sufficient to increase nixtamal moisture to 52%. Three kilograms of treatment was lime-cooked with 9 L of water containing 30 g of lime. The grain was added when the lime solution reached 100° C. After cooking, heat was discontinued, and the grain steeped in the hot lime solution for 16 hours. Then, the steep liquor was removed and the nixtamal washed with water. The cleaned nixtamal was weighed and sampled to determine its moisture (AACC, American Association of Cereal Chemists. Approved methods of the AACC, 10th edn. Association, St. Paul, Minn., pp 69-124, 2000). Dry matter loss was calculated using the following equation: DML=[(nixtamal dry weight/grain dry weight)−1]×100. The fresh nixtamal was ground into a fine dough or masa using a stone mill (Fertitor, Puebla, Mexico) equipped with a pair of carved stones of 23 cm diameter. Water was added during milling at a rate of 240 mL/min to increase the moisture content of the masa to 58-60% and to avoid excessive heat generation. The masas were sheeted and cut to form 30 g masa discs of 13.0 cm diameter and 1 mm of thickness. The disks were baked for 68 seconds into tortillas in a three-tier gas fired baking oven (Tortimaq y Diseilo, Guadajara, J C, Mexico) set at 291, 347 and 287° C. respectively. Baked tortillas were cooled for 30 min at room temperature (25±2° C.) and immediately placed inside sealed polyethylene bags and kept at room temperature for further evaluations (Sema-Saldívar, Cereal Grains: Laboratory Reference and Procedures Manual. Boca Raton: CRC Press. 394, 2012). Samples of germinated corn and tortillas were freeze-dried during 72 hours at −50° C. and 0.036 mbar (LABCONCO, Kansas City, Mo., USA). Freeze dried samples were milled in an electric coffee grinder (KRUPS GX4100, Germany). After milling, the samples were passed through a mesh sieve no. 60. The flours were stored in plastic bags at −20° C. until use. The moisture content was determined in all samples to express the results on a dry weight basis.

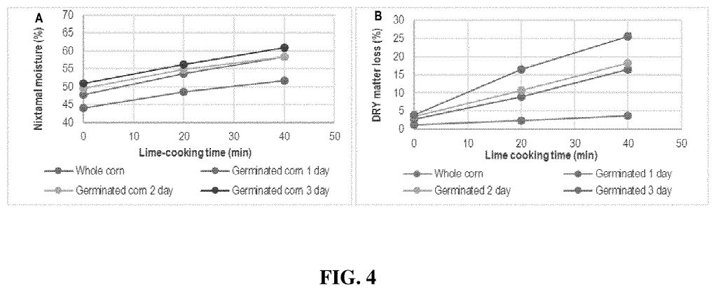

Moisture content in cooked whole corn is used as physicochemical criteria in order to establish optimum cooking time because the kernel absorbs water linearly as cooking time is extended. These studies indicated that lime-cooking time decreased significantly when germination time was prolonged, times from 39.15 of the control to 14.34, 8.42 and 2.80 min for the sprouted kernels were determined for samples germinated for 1 to 3 days, respectively (FIG. 4 and Table 2). The high initial moisture content of germinated corn promoted a reduction in the cooking time of nixtamal (Table 2). The water absorbed activated the enzymes normally produced which hydrolyze polysaccharides (starch and fiber), proteins and lipids. Especially the synthesis of α-amylase increased, which promoted starch degradation yielding dextrins and soluble sugars. Likewise, it has been reported than during nixtamalization the water diffusion depends strongly on three factors: 1) pericarp permeability; 2) the grain physical characteristics, mainly hardness and the compaction degree of starch granules, and 3) nixtamalization variables. Therefore, the significant decrease of lime-cooking time in sprouted corn observed herein is attributed to the higher degree of hydrolysis of the starch granules, which was observed in samples germinated for longer periods of time.

TABLE 2
Lime-cooking times and dry matter losses of control and germinated samples.

| | | | Lime- | | | | | |
|---|---|---|---|---|---|---|---|---|
| | | | cooking | | | Dry matter loss (%) | | |
| | | | time | | | Nixtama- | Germ- | |
| Treatment | Equations¹* | R2 | (min) | Equations²* | R2 | lization | ination | Total |
| Whole | (Y = 0.192X + | 0.996 | 39.15 | (Y = 0.0617X + | 0.999 | 3.29 | — | 3.29 |
| corn | 44.284) | | | 1.1576) | | | | |
| Germinated | (Y = 0.265X + | 0.995) | 14.34 | (Y = 0.3421X + | 0.997 | 7.39 | 0.98 ± 0.34^{c} | 8.37 |
| corn 1 day | 48 | | | 2.4814) | | | | |
| Germinated | (Y = 0.2162X + | 0.983 | 8.42 | (Y = 0.3666X + | 0.999 | 6.51 | 2.94 ± 0.15^{b} | 9.45 |
| corn 2 day | 49.979) | | | 3.4234) | | | | |
| Germinated | (Y = 0.2475X + | 0.998 | 2.80 | (Y = 0.5396X + | 0.991 | 6.10 | 4.23 ± 0.22 ^{a} | 10.33 |
| corn 3 day | 51.107) | | | 4.5907) | | | | |

Means ± standard deviation of three determinations. Mean values in each column sharing the same letter were not significantly different (p <0.05).
¹*= Linear regression equations for lime-cooking time values.
²*= Linear regression equations for dry matter loss values during nixtamalization process

On the other hand, this study showed an increase in the dry matter loss when spouted kernels were more extensively cooked (FIG. 4). Germinated corn during 1, 2 and 3 days showed dry matter losses of 7.39, 6.51 and 6.10% respectively, these data are greater than the 3.29% shown in whole (Table 2). Additionally, kernels germinated for 1-3 days showed dry matter losses of 0.98, 2.94 and 4.23. The 3-day sprouted corn sample showed the highest total dry matter loss, 3.10-fold compared to whole corn (Table 2). The alkaline hydrolysis of pericarp facilitates its separation during washing and increases the dry matter losses. Dry matter loss can reach 19% and pericarp components account for 49.8 to 79.1% of this. Factors increasing pericarp hydrolysis include a long cooking time (>37 min), a long steeping time (>16 h), and a high steeping temperature (>60° C.), as well as a high lime concentration (>1.0%). However, the use of sprouted grains during nixtamalization process is another important factor that increases the dry matter loss, as shown herein. A high hydrolysis degree of starch, proteins and lipids increases the solubilization and leaching of loss of nutrients into the soaking water. Also, the rootlets or radicles and acrospires of sprouted kernels are more susceptible to detach from grains contributing to higher dry matter losses.

In whole corn grains and tortilla were observed low levels of selenium by 0.154 and 0.122 μg/g dw, respectively, similar to selenium concentration reported for cereals grown in Mexico. The germinated corn in presence of sodium selenite (12 and 24 mg/L) increased selenium levels in sprouts to 0.5 and 0.7 μg/g dw, respectively, as well as in tortillas to 0.4 and 0.6 μg/g dw for the high and low dosage of selenite (Table 3). The results indicated that sprouted kernels enriched with selenium loss 11.61% to 51.29% of this important mineral during the tortilla making process (Table 3). Higher losses were observed in sprouted kernels treated with higher amounts of sodium selenite or in kernels germinated for longer times (Table 3).

TABLE 3
Selenium contents in sprouted corns (1-3 days) and tortillas
and percent selenium loss during nixtamalization.

| | | | | Selenium |
|---|---|---|---|---|
| | | Total selenium μg/g dw | | loss |
| Treatment | | Germinated corn | Tortilla | (%) |
| Whole corn | | 0.154 ± 0.001^{c} | 0.122 ± 0.004^{f} | 20.58 |
| Germinated 0* mg | 1 day | 0.156 ± 0.002^{c} | 0.093 ± 0.001^{g} | 40.25 |
| | 2 day | 0.154 ± 0.001^{c} | 0.083 ± 0.002^{h} | 46.10 |
| | 3 day | 0.155 ± 0.003^{c} | 0.076 ± 0.001ⁱ | 51.29 |
| Germinated 12* mg | 1 day | 0.559 ± 0.002^{b} | 0.435 ± 0.002^{c} | 22.23 |
| | 2 day | 0.567 ± 0.001^{b} | 0.401 ± 0.001^{d} | 29.24 |
| | 3 day | 0.565 ± 0.029^{b} | 0.332 ± 0.017^{e} | 41.29 |
| Germinated 24* mg | 1 day | 0.737 ± 0.003^{a} | 0.651 ± 0.032^{a} | 11.61 |
| | 2 day | 0.722 ± 0.008^{a} | 0.625 ± 0.002^{a} | 13.43 |
| | 3 day | 0.727 ± 0.007^{a} | 0.560 ± 0.015^{b} | 22.94 |

Means ± standard deviation of three determinations. Mean values in each column sharing the same letter were not significantly different (p <0.05). 0*, 12* and 24* = mg Na₂SeO₃/L water used during soaking.

While this disclosure has been described as having exemplary concentrations and times, the present disclosure can be further modified within the spirit and scope of this disclosure. For example, all of the disclosed components of the preferred and alternative embodiments are interchangeable providing disclosure herein of many processes having combinations of all the preferred and alternative embodiment components. This application is therefore intended to cover any variations, uses, or adaptations of the disclosure using its general principles. Further, this application is intended to cover such departures from the present disclosure as come within known or customary practice in the art to which this disclosure pertains and which fall within the limits of the appended claims.

1. A method of producing nixtamal comprising an increased level of selenium from a cereal, pulse/legume, oilseed or pseudocereal, comprising the steps of:
a) tempering, conditioning or soaking the cereal, pulse/legume, oilseed or pseudocereal in a solution comprising a selenium salt;
b) germination of the tempered, conditioned or soaked cereal, pulse/legume, oilseed or pseudocereal to produce a sprouted cereal, pulse/legume, oilseed or pseudocereal;
c) cooking the sprouted cereal, pulse/legume, oilseed or pseudocereal in a solution comprising lime, calcium hydroxide, wood ashes, potassium hydroxide or sodium hydroxide;
d) steeping the cooked and sprouted cereal, pulse/legume, oilseed or pseudocereal in the solution; and
e) draining the solution from the cooked and sprouted cereal, pulse/legume, oilseed or pseudocereal to produce nixtamal comprising an increased level of selenium.

2. The method of claim 1, wherein the method further comprises the step of washing the nixtamal.

3. The method of claim 1, wherein the cereal is corn, rice, wheat, barley, sorghum, millet, oats, rye, triticale, fonio, teff, wild rice or pearl, foxtail or Italian or Japanese millet.

4. The method of claim 3, wherein the cereal is corn.

5. The method of claim 1, wherein the pulse/legume is soybean, green peas, yellow or other colored peas, kidney bean, navy bean, pinto bean, black turtle bean, haricot bean, lima bean, butter bean, adzuki bean, mung bean, black gram, urad, scarlet runner bean, ricebean, moth bean, tepary bean, horse bean, broad bean, field bean, garden pea, protein pea, chickpea or garbanzo, bengal gram, dry cowpea, black-eyed pea, blackeye bean, pigeon pea, arhar/toor, cajan pea, congo bean, gandules, lentil, bambara groundnut, earth pea, vetch, common vetch, lupins, hyacinth bean, jack bean, winged bean, velvet bean, cowitch, or yam bean.

6. The method of claim 1, wherein the oilseed is soybean, peanut, castor bean, sunflower seed, rapeseed or canola, safflower seed, sesame seed, mustard seed, poppy seed, melonseed, hempseed, flax or linseed.

7. The method of claim 1, wherein the pseudocereal is amaranthus, buckwheat, chia, quinoa or huauzontle.

8. The method of claim 1, wherein the cereal, pulse/legume, oilseed or pseudocereal is tempered or conditioned prior to germination.

9. The method of claim 1, wherein the cereal, pulse/legume, oilseed or pseudocereal is soaked prior to germination.

10. The method of claim 9, wherein the cereal, pulse/legume, oilseed or pseudocereal is soaked for about 8 to about 24 hours at about 20-25° C. prior to germination.

11. The method of claim 10, wherein the soaked cereal, pulse/legume, oilseed or pseudocereal has a moisture of at least 34%.

12. The method of claim 11, wherein the soaked cereal, pulse/legume, oilseed or pseudocereal has a moisture of about 36% to about 38%.

13. The method of claim 1, wherein the selenium salt is sodium selenite, potassium selenite or selenium dioxide.

14. The method of claim 1, wherein the solution comprises about 10 mg/liter to about 25 mg/liter of the selenium salt.

15. The method of claim 1, wherein the tempered, conditioned or soaked cereal, pulse/legume, oilseed or pseudocereal is germinated for about 24 to about 72 hours at about 20-25° C. at about 85% relative humidity.

16. The method of claim 1, wherein the sprouted cereal, pulse/legume, oilseed or pseudocereal is cooked at about 85-100° C. for about 1 to about 10 minutes.

17. The method of claim 1, wherein the cooked and sprouted cereal, pulse/legume, oilseed or pseudocereal is steeped for about 8 to about 16 hours.

18. The method of claim 1, wherein the nixtamal comprises a nutritional level of selenium.

19. The method of claim 1, wherein the nixtamal comprises a supra-nutritional level of selenium.

20. The method of claim 1, wherein the nixtamal is ground to produce masa or dough particles.

21. The method of claim 20, wherein the masa or dough particles have a fine granulometry.

22. The method of claim 21, wherein the masa or dough particles having a fine granulometry are used to produce tortillas.

23. The method of claim 22, wherein the masa or dough particles having a fine granulometry are produced from corn and are used to produce corn tortillas.

24. The method of claim 20, wherein the masa or dough particles have a coarse granulometry.

25. The method of claim 24, wherein the masa or dough particles having a coarse granulometry are used to produce snack chips or tostadas.

26. The method of claim 25, wherein the masa or dough particles having a coarse granulometry are produced from corn and are used to produce corn snack chips or corn tostadas.

27. The method of claim 20, wherein the masa or dough particles are dried or dehydrated.

28. A food product produced from cereal, pulse/legume, oilseed or pseudocereal nixtamal comprising an increased level of selenium.

29. The food product of claim 28, wherein the food product comprises a nutritional level of selenium.

30. The food product of claim 28, wherein the food product comprises a supra-nutritional level of selenium.

31. The food product of claim 28, wherein the food product is produced from corn nixtamal comprising an increased level of selenium.

32. The food product of claim 31, wherein the food product is corn tortillas, corn snack chips or corn tostadas.

33. The food product of claim 28, wherein the cereal, pulse/legume, oilseed or pseudocereal nixtamal comprising an increased level of selenium is produced using the method of claim 1.

34. The food product of claim 33, wherein the food product is produced from corn nixtamal comprising an increased level of selenium.

35. A corn tortilla, corn snack chip or corn tostada comprising an increased level of selenium.

36. The corn tortilla, corn snack chip or corn tostada of claim 35, comprising a nutritional level of selenium.

37. The corn tortilla, corn snack chip or corn tostada of claim 35, comprising a supra-nutritional level of selenium.
